(19) United States
(12) Patent Application Publication
(10) Pub. No.: US 2024/0289691 A1
(43) Pub. Date: Aug. 29, 2024

(54) MACHINE LEARNING MODEL IMPROVEMENT MEASURE PRESENTING APPARATUS

(71) Applicant: NEC Corporation, Minato-ku, Tokyo (JP)

(72) Inventor: Masato Hoshika, Tokyo (JP)

(73) Assignee: NEC Corporation, Minato-ku, Tokyo (JP)

(21) Appl. No.: 18/572,936

(22) PCT Filed: Jun. 29, 2021
(86) PCT No.: PCT/JP2021/024491

§ 371 Date: Dec. 21, 2023

(51) Int. Cl. G06N 20/00

(52) U.S. Cl. CPC G06N 20/00

(57) ABSTRACT

An information processing apparatus includes accuracy degradation cause acquisition means for acquiring a cause of accuracy degradation of an analysis model, improvement measure acquisition means for acquiring an improvement measure of the analysis model that corresponds to the cause of the accuracy degradation of the analysis model, and display means for displaying the improvement measure of the analysis model

### TECHNICAL FIELD

The present disclosure relates to an information processing apparatus, an information processing method, and a non-transitory computer readable medium.

### BACKGROUND ART

In the field of machine learning (AI), in order to improve the accuracy of analysis models, a person in charge studies a specific analysis model improvement measure based on experience and intuition (intuition based on experience). The analysis models are the results of learning generated by machine learning (AI). Accuracy degradation means that a difference between a predicted value that an analysis model returns and the actual value becomes large due to a change in data to be input to the analysis model.

### CITATION LIST

### Patent Literature

[Patent Literature 1] Japanese Unexamined Patent Application Publication No. 2020-144504

### SUMMARY OF INVENTION

### Technical Problem

However, considerable amount of experience to study the specific analysis model improvement measure is required, which causes a problem that it is difficult for a person who participates in system development in the middle of a process or for beginners in the AI field to make a plan for an appropriate improvement measure.

The present disclosure has been made in view of the aforementioned problem, and an aim of the present disclosure is to provide an information processing apparatus, an information processing method, and a non-transitory computer readable medium capable of presenting an appropriate improvement measure.

### Solution to Problem

An information processing apparatus according to the present disclosure includes: accuracy degradation cause acquisition means for acquiring a cause of accuracy degradation of an analysis model; improvement measure acquisition means for acquiring an improvement measure of the analysis model that corresponds to the cause of the accuracy degradation of the analysis model; and display means for displaying the improvement measure of the analysis model.

An information processing method according to the present disclosure includes: an accuracy degradation cause acquisition step of acquiring a cause of accuracy degradation of an analysis model; an improvement measure acquisition step of acquiring an improvement measure of the analysis model that corresponds to the cause of the accuracy degradation of the analysis model; and display step means for displaying the improvement measure of the analysis model.

A non-transitory computer readable medium according to the present disclosure is a non-transitory computer readable medium storing a program for executing an information processing method, in which the information processing method includes: an accuracy degradation cause acquisition step of acquiring a cause of accuracy degradation of an analysis model; an improvement measure acquisition step of acquiring an improvement measure of the analysis model that corresponds to the cause of the accuracy degradation of the analysis model; and display step means for displaying the improvement measure of the analysis model.

### Advantageous Effects of Invention

According to the present disclosure, it is possible to provide an information processing apparatus, an information processing method, and a non-transitory computer readable medium capable of presenting an appropriate improvement measure.

### BRIEF DESCRIPTION OF DRAWINGS

FIG. 1 is a block diagram showing a configuration example of an information processing apparatus according to a first example embodiment;

FIG. 2 is a diagram showing a configuration example of an information processing apparatus according to a second example embodiment;

FIG. 3 is a diagram showing information held by a repository 10 (an information holding unit 11);

FIG. 4 is a diagram showing a relation between an information input unit 21 and the information holding unit 11;

FIG. 5 is a diagram showing a relation between an information analysis unit 22 and the information holding unit 11;

FIG. 6 is a flowchart of processing for acquiring an improvement measure for an analysis model from an information processing apparatus 100 (an AI model management apparatus) and repeating the improvement measure;

FIG. 7 is a flowchart of details of Step S19;

FIG. 8 shows specific examples of a degradation cause classification, a search target, display conditions, etc.;

FIG. 9 shows specific examples of a degradation cause classification, display conditions, and improvement measures (recommendations);

FIG. 10 is a flowchart of processing for tuning parameters (degradation determination thresholds) to be passed to an AI model degradation cause estimation apparatus 50; and

FIG. 11 is a diagram showing a hardware configuration example of an information processing apparatus according to the present disclosure.

### EXAMPLE EMBODIMENT

Hereinafter, with reference to the drawings, example embodiments of the present invention will be described. Note that the following descriptions and the drawings are omitted and simplified as appropriate for the sake of clarification of the explanation. Throughout the drawings, the same components are labeled with the same references, and the description thereof is omitted as necessary.

First, terms used in the present disclosure will be described. In the present disclosure, a design pattern showing a pattern for designing a learning model is called a “case”. Further, in the present disclosure, the “case” is defined as a term that may include design information for performing creation, verification, and evaluation of an analysis model as well. The design information may include specification of an AI engine, specification of data for learning, data for verification, and data for evaluation, specification of hyperparameters and data dividing conditions, and specification of parameters used for executing the AI engine, other than hyperparameters. Further, the design information may include a source code or the like of an AI engine execution program. When, for example, a first learning model has been created based on a first design pattern, the first design pattern is referred to as a first case and information regarding the first design pattern (information used for the first design pattern) is referred to as first case information. Further, in the present disclosure, the learning model may be referred to as an analysis model.

### First Example Embodiment

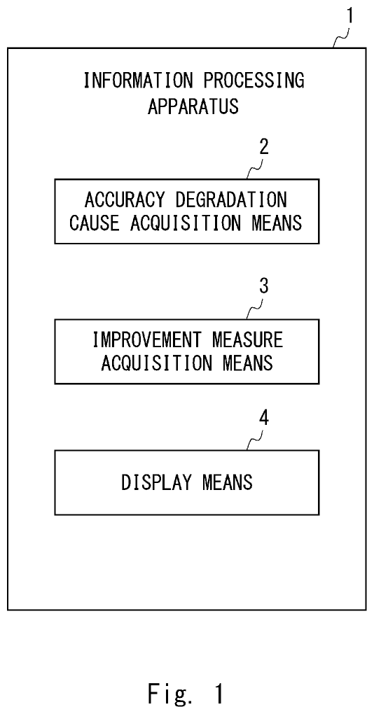

With reference to FIG. 1, a configuration example of an information processing apparatus 1 according to a first example embodiment will be described. FIG. 1 is a block diagram showing a configuration example of an information processing apparatus according to the first example embodiment. The information processing apparatus 1 may be a personal computer or may be a server. The information processing apparatus 1 includes accuracy degradation cause acquisition means 2, improvement measure acquisition means 3, and display means 4.

The accuracy degradation cause acquisition means 2 acquires, for example, a cause of accuracy degradation of an analysis model output from a degradation cause estimation apparatus (e.g., an AI model degradation cause estimation apparatus 50 that will be described later). Further, the accuracy degradation cause acquisition means 2 may acquire a cause of accuracy degradation of an analysis model input by a user through an input device (e.g., an input device 30 that will be described later).

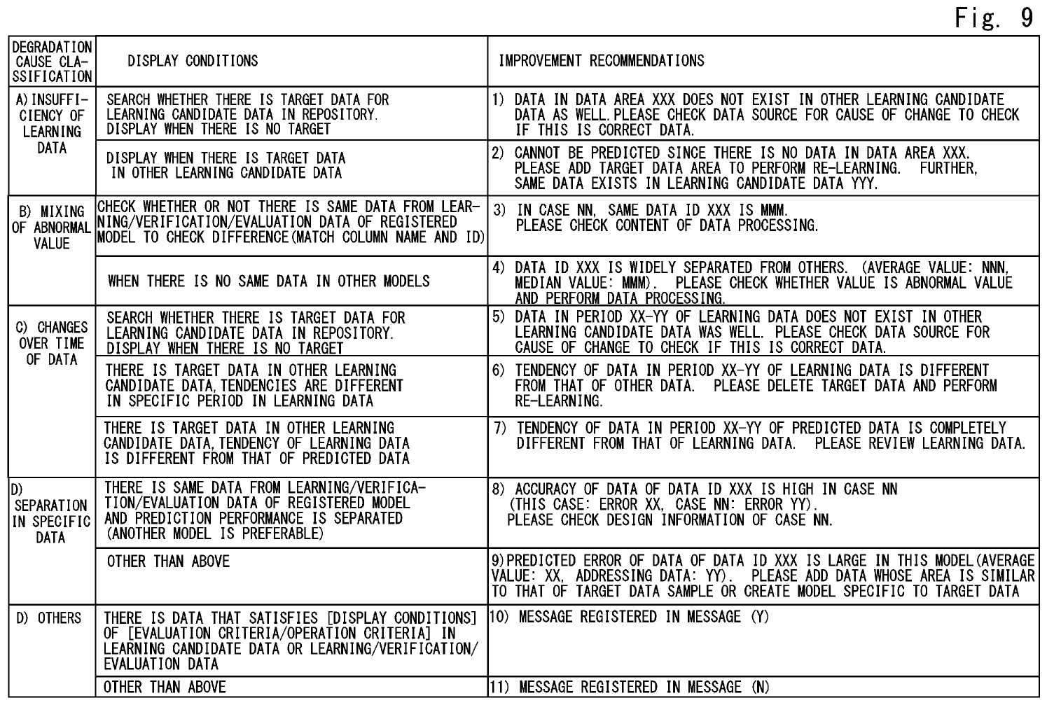

The improvement measure acquisition means 3 acquires an improvement measure of the analysis model that corresponds to the cause of the accuracy degradation of the analysis model (e.g., recommendation that will be described later, see improvement recommendations in FIG. 9). FIG. 9 shows specific examples of degradation cause classification, display conditions, and improvement measures (recommendations).

The display means 4 (e.g., an output device 40 that will be described later) displays an improvement measure (e.g., recommendation that will be described later, see improvement recommendations in FIG. 9) of the analysis model.

As described above, according to the first example embodiment, the display means 4 (e.g., the output device 40 that will be described later) displays the improvement measure (e.g., recommendation that will be described later, see improvement recommendations in FIG. 9) of the analysis model that corresponds to the cause of the accuracy degradation of the analysis model, whereby it is possible to present an appropriate improvement measure.

### Second Example Embodiment

Next, a second example embodiment will be described. The second example embodiment is an example embodiment in which the first example embodiment is made more specific.

### <Configuration Example of Information Processing Apparatus>

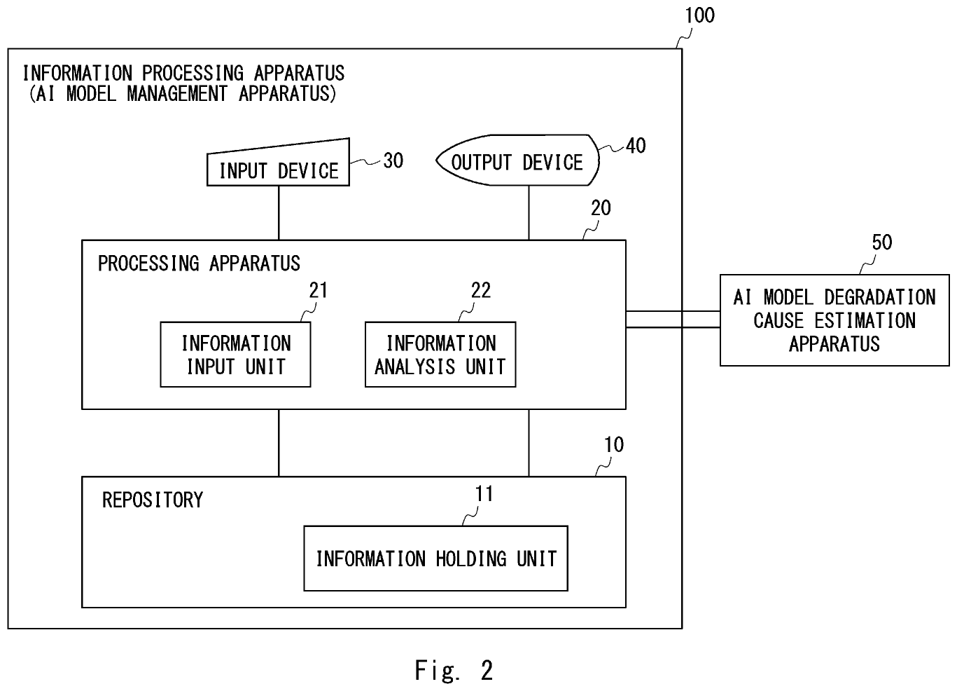

With reference to FIG. 2, a configuration example of an information processing apparatus 100 according to the second example embodiment will be described. FIG. 2 is a diagram showing a configuration example of the information processing apparatus according to the second example embodiment. The information processing apparatus 100 corresponds to the information processing apparatus 1 according to the first example embodiment. The information processing apparatus 100 is an apparatus that analyzes an analysis model, which is a learning model that has been subjected to machine learning. Hereinafter, the information processing apparatus 100 is also referred to as an AI model management apparatus 100.

The information processing apparatus 100 presents a specific analysis model improvement measure (recommendation) based on information on the cause of the accuracy degradation of the analysis model and data accumulated in the information processing apparatus 100 (the AI model management apparatus).

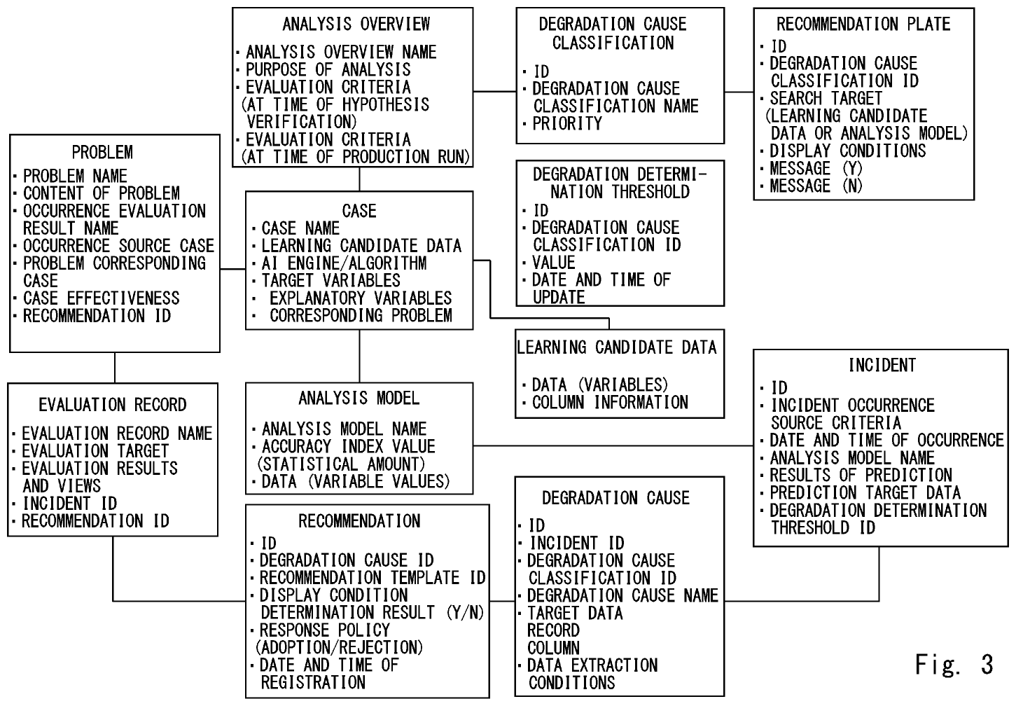

The analysis model means results of learning generated by machine learning (AI). The analysis model outputs, in response to input, results of classification or results of prediction (e.g., results of prediction by regression (linear regression)) based on the results of learning. In the AI engine, the input corresponds to the data for learning and the output corresponds to the analysis model, whereas in the analysis model, the input corresponds to prediction target data and the output corresponds to results of the prediction. The analysis model is included, for example, in the following analysis model information (see FIG. 3). The accuracy degradation means that a difference between a predicted value that an analysis model returns and the actual value becomes large due to a change in data to be input to the analysis model.

The information processing apparatus 100 may be a personal computer or may be a server. The information processing apparatus 100 includes a repository 10, a processing apparatus 20, an input device 30, and an output device 40. In the following description, a learning model analyzed by the information processing apparatus 100 is described as an analysis model.

The repository 10 is a storage device that stores (holds) case information analyzed by the information processing apparatus 100, and various kinds of information related to the case information. The repository 10 may be, for example, NEC Advanced Analytics Platform Modeler (AAPF Modeler). The repository 10 includes an information holding unit 11.

The information holding unit 11 inputs various kinds of information received by the information input unit 21 included in the processing apparatus 20 from the information input unit 21 and holds these information items. The information holding unit 11 may be referred to as a storage unit.

With reference now to FIG. 3, various kinds of information held (accumulated) by the information holding unit 11 will be described. FIG. 3 is a diagram showing information held by the repository 10 (the information holding unit 11). As shown in FIG. 3, the information holding unit 11 holds analysis overview information, case information, analysis model information, evaluation record information, and problem information. Further, the information holding unit 11 holds information on degradation cause classification, a degradation determination threshold, a recommendation template, an incident, a degradation cause, and a recommendation.

The analysis overview information is created for each purpose of analysis to be performed by the analysis model, which is the learning model. When, for example, a user who uses the analysis model (a person in charge of analysis) wants to predict electric power demand and the purpose of analysis is to predict electric power demand, analysis overview information aiming to analyze “prediction of electric power demand” is created. When, for example, a user who uses the analysis model wants to predict sales, not electric power demand, and the purpose of analysis is to predict sales, analysis overview information aiming to analyze “sales prediction” is created. The analysis overview information includes an analysis overview name and a purpose of analysis. Further, the analysis overview information that bundles cases includes evaluation criteria of the analysis model (at a time of hypothesis verification) used at the time of hypothesis verification of the analysis model, the evaluation criteria of the analysis model (at a time of production run) used at the time of production run of the AI system.

The name of the analysis overview is set as the analysis overview name.

The purpose of creating the analysis model is set as the purpose of analysis. When the aforementioned example is used, for example, “prediction of electric power demand” or “sales prediction” is set as the purpose of analysis.

Information on the evaluation criteria of the analysis model used at the time of hypothesis verification of the analysis model is set as the evaluation criteria (at the time of hypothesis verification).

Information on the evaluation criteria of the analysis model used at the time of production run of the AI system is set as the evaluation criteria (at the time of production run).

The case information is information regarding a case (design information, design pattern) for creating an analysis model based on the analysis overview information. After one piece of analysis overview information is created, an analysis model with a high prediction accuracy in accordance with the purpose of analysis or the like included in this analysis overview information or the like is created. Since it is generally difficult to create an analysis model with a high prediction accuracy from only a single design, a plurality of cases are created by trial and error with multiple designs and the analysis model is evaluated, whereby an analysis model with a high prediction accuracy is created. Therefore, a plurality of case information items are created from one piece of analysis overview information. That is, the analysis overview information is information that bundles a plurality of case information, and the information holding unit 11 holds, for example, the analysis overview information and the case information in a layered manner. In other words, the information holding unit 11 holds the case information so as to be stored in a hierarchy one level below the analysis overview information. Therefore, the analysis overview information and the case information are held by the information holding unit 11 in order to be able to specify the corresponding information by tracing the held hierarchy. The case information includes a case name, learning candidate data, an AI engine algorithm, target variables, explanatory variables, and a corresponding problem.

A name for specifying the case for designing the analysis model is set as the case name.

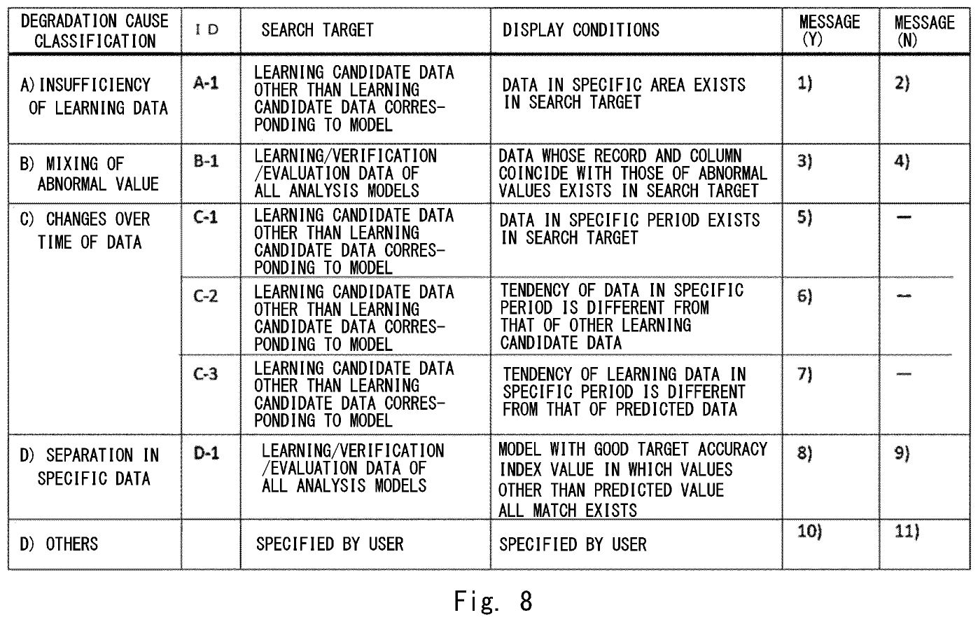

A set of data that may be used to create the analysis model is set as the learning candidate data. The learning candidate data includes data (variables) and column information. Specifically, a plurality of variable names that may be used as target variables and explanatory variables, and data such as numerical values of the respective variables are set as the learning candidate data. Note that the learning candidate data may include variables that are not used as the target variables and the explanatory variables. The learning candidate data shown in FIG. 8 corresponds to the learning candidate data shown in FIG. 3. FIG. 8 shows specific examples of the degradation cause classification, the search target, and the display conditions.

An AI engine name and an algorithm name used by the AI engine are set as the AI engine algorithm. The AI engine is a general term for AI that performs analysis based on a specific algorithm classification. The AI engine means a system for implementing analysis processing such as prediction and determination by generating an analysis model using a machine learning technique along a predetermined data analysis method. The AI engine is, for example, a commercially available software program or an open source software program. The AI engine may be, for example, scikit-learn and PyTorch.

A variable name (target variable name) of information to be predicted by the analysis model (prediction target data) and a data type are set as the target variables. The data type of the target variables, which indicates the type of the values of the target variables, is a label used for classification. The data type may be, for example, a category type and a numeric type. When, for example, “prediction of electric power demand” is the purpose of analysis, the “actual record (in units of 10,000 kW)” indicating the target variable name of the actual electric power regarding the demand for electric power and the data type of the target variables are set as the target variables.

Names of variables (explanatory variable names), which are a plurality of variables used by the analysis model at the time of prediction and are assumed to influence the target variables, are set as the explanatory variables. All the explanatory variable names are set as the explanatory variables in a form of, for example, a list of variables. When, for example, the “prediction of electric power demand” is the purpose of analysis, variable names such as “temperature”, “precipitation”, and “actual record (in units of 10,000 kW)_two days ago” indicating the actual electric power two days ago, which are used to predict the demand for electric power, that is, target variables, are set as the explanatory variables as a list of variables.

The corresponding problem, which is information related to problem information that will be described later, and a problem to be solved in each case is set as the corresponding problem. When, for example, it has been revealed as a result of evaluation of one analysis model created by one case that the amount of data regarding “temperature” included in the learning candidate data is insufficient, a problem that “the amount of data regarding “temperature” is insufficient” is set as the problem information. When the case that is newly reviewed is based on learning candidate data to which data regarding the “temperature” is added, “the amount of data regarding “temperature” is insufficient” is set as the corresponding problem included in the case information of the above case.

Information regarding the analysis model created from one case information item is set as the analysis model information. Since a plurality of analysis models may be created from one case, at least one analysis model information item is associated with one case information item. The information holding unit 11 holds the analysis overview information, the case information, and the analysis model information in a layered manner. Specifically, the information holding unit 11 holds the analysis overview information, the case information, and the analysis model information in such a way that the case information is stored in a hierarchy one level below the analysis overview information and the analysis model information is stored in a hierarchy one level below the case information. Therefore, the analysis overview information, the case information, and the analysis model information are held by the information holding unit 11 in order to be able to specify the corresponding information by tracing the held hierarchy. The analysis model information includes an analysis model name, an accuracy index value (statistical amount), and data (variable values).

The name of an analysis model is set as the analysis model name.

An accuracy index value of the analysis model is set as the accuracy index value (statistical amount). The accuracy index value is, for example, a mean absolute error calculated from the data of the analysis model registered in the repository 10.

“Learning/verification/evaluation data” in FIG. 8 is, for example, set as data (variable values).

The evaluation record information is information regarding a record when the case information and the analysis model information of the evaluation target are evaluated. The evaluation record information includes an evaluation record name, an evaluation target, evaluation results and views, an incident ID, and a recommendation ID.

The name of the evaluation record is set as the evaluation record name.

Information for specifying the case regarding the analysis model of the evaluation target is set as the evaluation target.

Regarding the analysis model and the case of the evaluation target, the views of the user performing the evaluation are set as the evaluation results and views.

Information for identifying the incident regarding the analysis model of the evaluation target is set as the incident ID.

Information for identifying the recommendation regarding the analysis model of the evaluation target is set as the recommendation ID.

Information regarding a problem revealed from the evaluation record information is set as the problem information. When, for example, it has been revealed as a result of evaluation of one analysis model created by one case that the amount of data regarding “temperature” included in the learning candidate data is insufficient, information regarding a problem that “the amount of data regarding “temperature” is insufficient” is set as the problem information. The problem information includes a problem name, the content of the problem, an occurrence evaluation result name, an occurrence source case, a problem corresponding case, case effectiveness (presence or absence of case effect), and a recommendation ID.

The name of the problem is set as the problem name. When the problem information is information regarding a problem that “the amount of data regarding “temperature” is insufficient”, for example, information such as “insufficiency of data regarding temperature” is set as the problem name.

A specific content of the problem is set as the content of the problem. When the problem information is information regarding the problem that “the amount of data regarding “temperature” is insufficient”, for example, information such as “the amount of data regarding “temperature” included in the learning candidate data is insufficient” is set as the content of the problem.

An evaluation record name included in the evaluation record information where a problem has been revealed is set as the occurrence evaluation result name.

Information for specifying a case where a problem has been revealed is set as the occurrence source case. Information for specifying the case set in the evaluation target included in the evaluation record information where a problem has been revealed is set as the occurrence source case.

Information for specifying a case corresponding to a problem is set as the problem corresponding case. When, for example, a new case has been created for a problem, this case is set as the problem corresponding case.

Results of a determination regarding whether or not new cases that correspond to a problem each solve the problem is set as the case effectiveness (presence or absence of case effect). Assume that two new cases are created for a problem, and the first case does not solve the problem, while the second case solves the problem. In this case, as the information regarding the case effectiveness (presence or absence of case effect), information indicating that the problem has not solved is set for the first case and information indicating that the problem has been solved is set for the second case.

Information for identifying a recommendation is set as the recommendation ID.

A template (recommendation template) for forming a name, parameters (degradation determination thresholds) to be passed to the AI model degradation cause estimation apparatus 50, and an improvement measure (recommendation) of the analysis model that corresponds to the degradation cause are set as the degradation cause classification. When the degradation determination threshold is updated, information items with different dates and times of update are added, and the history of update is left. The degradation cause classification includes an ID, a degradation cause classification name, and a priority.

Information for identifying the degradation cause classification is set as the ID.

The degradation cause classification name is set as the degradation cause classification name. Specific examples of the degradation cause classification name are shown in FIG. 8 (see degradation cause classification in FIG. 8).

A priority of the degradation cause classification name is set as the priority.

The degradation determination threshold includes an ID, a degradation cause classification ID, a value, and the date and time of update.

Information for identifying the degradation determination threshold is set as the ID.

A degradation cause classification ID associated with the degradation cause determination threshold is set as the degradation cause classification ID.

A specific value of the degradation determination threshold is set as the value. Note that the degradation determination threshold is also referred to as a parameter.

The date and time when the degradation determination threshold is updated is set as the date and time of update.

The recommendation template is formed of a search range and conditions for checking the analysis model registered in the AI model management apparatus 100 in accordance with the degradation cause, and messages indicating an improvement measure for the degradation cause. The recommendation template includes an ID, a degradation cause classification ID, a search target (learning candidate data or analysis model), display conditions, a message (Y), and a message (N).

Information for identifying the recommendation template is set as the ID.

A degradation cause classification ID associated with the recommendation template is set as the degradation cause classification ID.

Information for specifying the search target is set as the search target (learning candidate data or analysis model). Specific examples of the search target are shown in FIG. 8.

Conditions for displaying the messages are set as the display conditions. Specific examples of the display conditions are shown in FIG. 8.

A message displayed when the display conditions are met is set as the message (Y). Specific examples of the message (Y) are shown in FIGS. 8 and 9 (e.g., see 1), 3), 5), 6), 7), 8), and 10) in FIGS. 8 and 9).

A message displayed when the display conditions are not met is set as the message (N). Specific examples of the message (N) are shown in FIGS. 8 and 9 (e.g., see 2), 4), 9), and 11) in FIGS. 8 and 9).

The incident is issued when an analysis model does not satisfy evaluation criteria. The incident has information input to the degradation estimation apparatus of the analysis model (data of the analysis model, the degradation determination threshold). The incident includes an ID, incident occurrence source criteria, the date and time of occurrence, an analysis model name, results of the prediction, prediction target data, and a degradation determination threshold ID.

Information for identifying the incident is set as the ID.

Evaluation criteria (at a time of hypothesis verification) or evaluation criteria (at a time of production run) are set as the incident occurrence source criteria. The incident occurrence source criteria are items for managing, on the AI model management apparatus 100, which one of the criteria at the time of hypothesis verification or the criteria at the time of production run the criteria are.

The date and time when processing is performed are set as the date and time of occurrence.

The name of the uploaded analysis model (to be analyzed) is set as the as the analysis model name.

The uploaded results of the prediction are set as the results of the prediction. The results of the prediction mean results of the prediction that the analysis model outputs in response to an input, for example, results of the prediction based on results of learning (e.g., results of the prediction by regression (linear regression)). A specific example of the results of the prediction is, for example, results of prediction of weather forecast. The results of the prediction are included in the analysis model from before an incident is issued.

The prediction target data that has been uploaded is set as the prediction target data. The prediction target data means data input to the analysis model that has been learned. A specific example of the prediction target data is, for example, ground-truth data of the weather forecast. The prediction target data is included in the analysis model from before the incident is issued.

The ID of the “degradation determination threshold” that the “degradation cause classification” has is set as the degradation determination threshold ID. The degradation determination threshold is used, for example, to evaluate (determine) the distance between the results of the prediction and the ground-truth data in the AI model management apparatus 100.

Note that the results of the prediction, the prediction target data, and the degradation determination threshold are necessary to estimate the degradation cause of the model, and items other than those stated above may be omitted. The incident (incident information) including at least the results of the prediction, the prediction target data, and the degradation determination threshold is one example of the information that is required to estimate the cause of the accuracy degradation according to the present disclosure.

The degradation cause has information (name, location of the data that serves as the basis) regarding the degradation cause returned from the analysis model degradation estimation apparatus and information on the incident of the input. The degradation cause includes an ID, an incident ID, a degradation cause classification ID, a degradation cause name, target data, record, column, and data extraction conditions.

Information for identifying the degradation cause is set as the ID.

Information for identifying the incident associated with the degradation cause is set as the incident ID.

Information for identifying the degradation cause classification that corresponds to the degradation cause is set as the degradation cause classification ID.

The specific name of the degradation cause is set as the degradation cause name.

The target data includes a record and a column. The record and the column are information for identifying the part which causes degradation in the analysis data. Since the data is in a form of a table (matrix), the number of the row is set in the record and the number (or the name) of the column is set in the column. By referring to the record and the column, it is possible to specify one data item which causes degradation.

Conditions for narrowing down the area or the period of a part such as a “specific area” or a “specific period” in “display conditions” in FIG. 8 are set as the data extraction conditions.

A recommendation is generated based on the information on the degradation cause and the recommendation template when a degradation cause is returned from the AI model degradation cause estimation apparatus 50. The recommendation has information regarding the analysis model improvement measures and information on the result of the adoption. The recommendation includes an ID, a degradation cause ID, a recommendation template ID, a display condition determination result (Y/N), response policy (adoption/rejection), and the date and time of registration.

Information for identifying the recommendation is set as the ID.

Information for identifying the degradation cause is set as the degradation cause ID.

Information for identifying the recommendation template is set as the recommendation template ID.

A display condition determination result (Y/N) is set as the display condition determination result (Y/N).

Adoption/rejection of the response policy is set as the response policy (adoption/rejection).

The date and time when a recommendation is registered are set as the date and time of registration.

Referring once again to FIG. 2, a configuration example of the processing apparatus 20 will be described. The processing apparatus 20 functions as a control unit that executes various kinds of control on the data input from the input device 30. Further, the processing apparatus 20 analyzes the analysis overview information, the case information, and the analysis model information using various kinds of information held by the repository 10, and outputs the results of the analysis to the output device 40. The processing apparatus 20 performs an operation on an external system. The processing apparatus 20 includes an information input unit 21 and an information analysis unit 22.

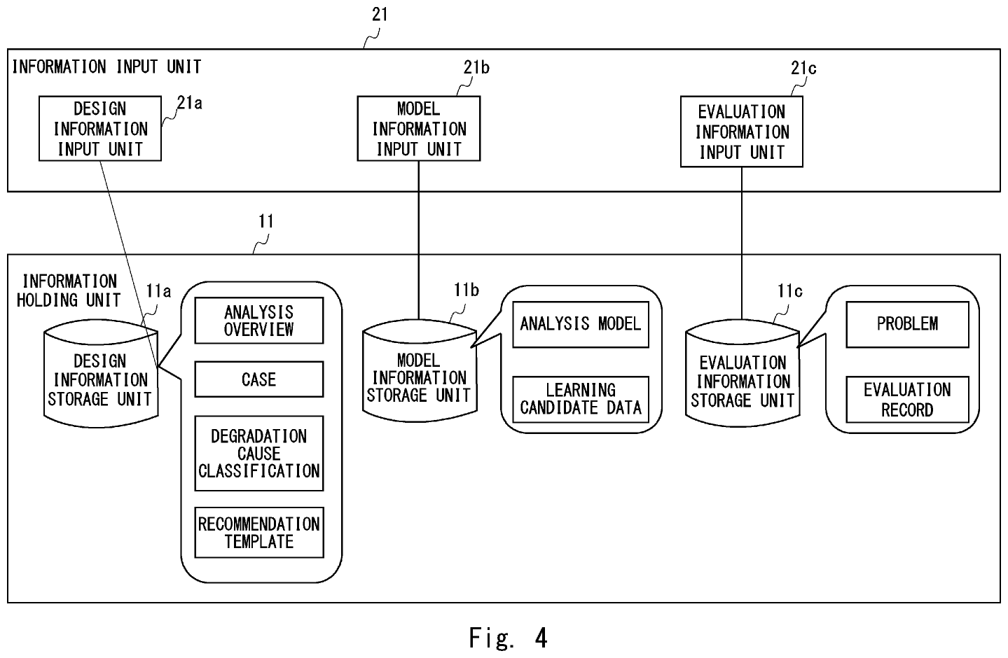

FIG. 4 is a diagram showing a relation between the information input unit 21 and the information holding unit 11.

As shown in FIG. 4, the information input unit 21 includes a design information input unit 21a, a model information input unit 21b, and an evaluation information input unit 21c. Further, the information holding unit 11 (repository 10) includes a design information storage unit 11a, a model information storage unit 11b, and an evaluation information storage unit 11c.

The design information input unit 21a registers (stores) the analysis overview, the case, the degradation cause classification, and the recommendation template that the user has input (uploaded) from the input device 30 in the information holding unit 11 (the design information storage unit 11a).

The model information input unit 21b associates the analysis model (file) and the learning candidate data that the user has input (uploaded) from the input device 30 with the case registered in advance and registers (stores) the associated information in the repository 10 (the model information storage unit 11b).

The evaluation information input unit 21c registers (stores) the problem and the evaluation record that the user has input (uploaded) from the input device 30 in the repository 10 (the evaluation information storage unit 11c).

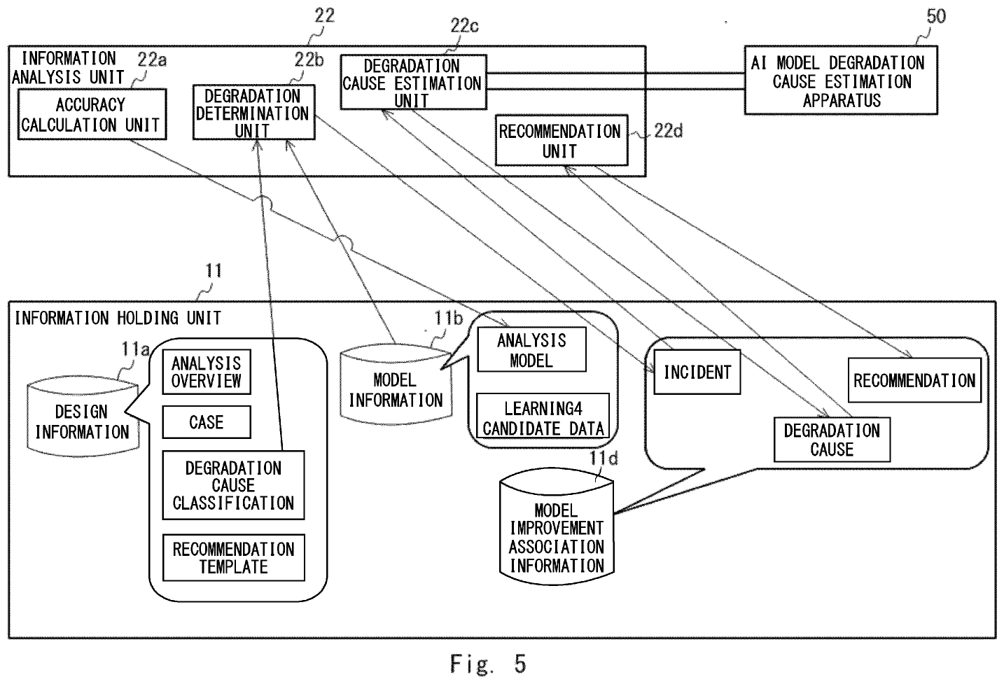

FIG. 5 is a diagram showing a relation between the information analysis unit 22 and the information holding unit 11.

As shown in FIG. 5, the information analysis unit 22 includes an accuracy calculation unit 22a, a degradation determination unit 22b, a degradation cause estimation unit 22c, and a recommendation unit 22d.

The accuracy calculation unit 22a calculates accuracy index values such as a mean absolute error from data of the analysis model registered in the repository 10 (the model information storage unit 11b).

The degradation determination unit 22b compares the results of the calculation in the accuracy calculation unit 22a with the values of the evaluation criteria registered from the design information input unit 21a in advance to determine whether or not the evaluation criteria are met. Further, the degradation determination unit 22b generates information (incident) to be input to the AI model degradation cause estimation apparatus 50 from data of the analysis model (results of the prediction, prediction target data) and the parameter (degradation determination threshold).

The degradation cause estimation unit 22c inputs information on the incident to the AI model degradation cause estimation apparatus 50 and acquires information on the degradation cause from the output from the AI model degradation cause estimation apparatus 50.

The recommendation unit 22d issues recommendations for the degradation cause.

The input device 30 functions as an input unit. The input device 30 may be, for example, a keyboard, a mouse, a touch panel or the like. The input device 30 outputs, when the user has input various kinds of information held by the information holding unit 11 of the repository 10 into the input device 30, input information to the information input unit 21. The input device 30 outputs, when the user has input the analysis model to be analyzed by the information analysis unit 22 and the analysis model to be compared to the input device 30, this information to the information input unit 21.

The output device 40 functions as an output unit. The output device 40 is configured, for example, to include a display and the like. The output device 40 displays the results of the computation performed in the processing apparatus 20 for the user.

As shown in FIG. 2, the AI model degradation cause estimation apparatus 50 is electrically connected to the information processing apparatus 100 (the processing apparatus 20). The AI model degradation cause estimation apparatus 50 estimates (specifies) the degradation cause of the analysis model by executing predetermined processing based on information on the incident input from the information processing apparatus 100 (the processing apparatus 20), and outputs information on the degradation cause that has been estimated. The AI model degradation cause estimation apparatus 50 specifies, based on the results of the prediction, prediction target data (ground-truth data), and the degradation determination threshold, the degradation cause (degradation cause classification ID, etc.) from a database (not shown) that stores degradation causes (degradation cause classification IDs, etc.), and outputs the specified degradation cause (degradation cause classification ID, etc.). At this time, the AI model degradation cause estimation apparatus 50 evaluates (determines), based on the results of the prediction, prediction target data (ground-truth data), and the degradation determination threshold, whether or not the distance between the results of the prediction and the ground-truth data has exceeded the degradation determination threshold, thereby outputting information (record, column) for specifying the part which causes degradation.

### <Operation Example of Information Processing Apparatus>

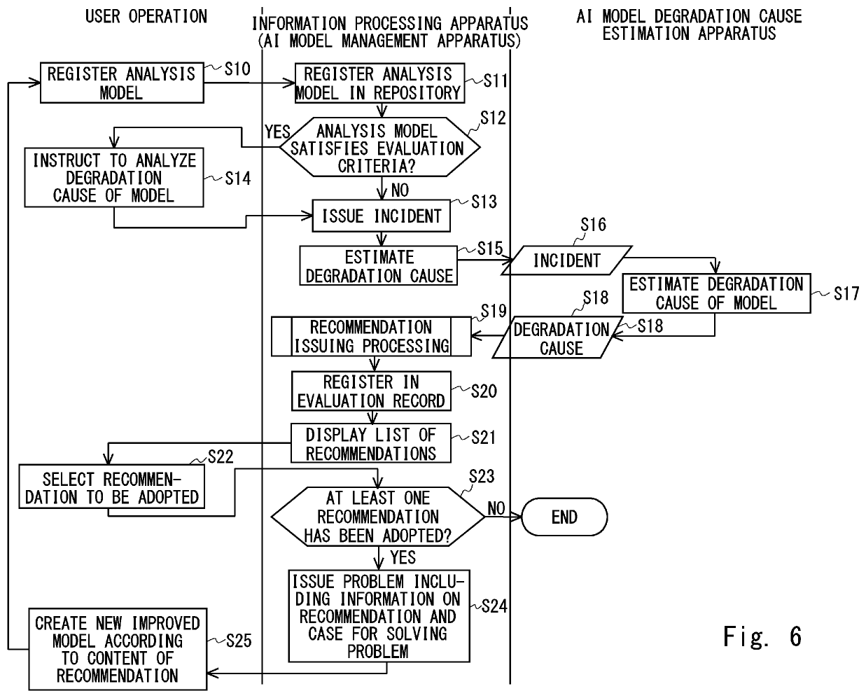

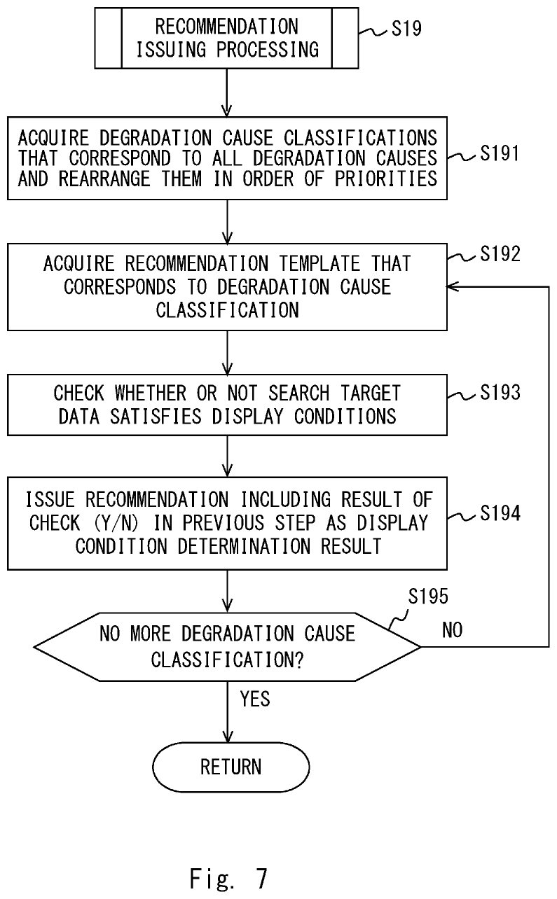

Referring next to FIGS. 6 and 7, an operation example of the information processing apparatus 100 will be described.

Hereinafter, processing for acquiring improvement measures for the analysis model from the information processing apparatus 100 (the AI model management apparatus) and repeating the improvement measures will be described.

FIG. 6 is a flowchart of processing for acquiring improvement measures for the analysis model from the information processing apparatus 100 (the AI model management apparatus) and repeating the improvement measures. FIG. 7 is a flowchart of the details of Step S19.

Hereinafter, it is assumed that the analysis overview, the degradation cause classification, the degradation determination threshold, and the recommendation template are registered in the repository 10 in advance.

First, the analysis model is registered (Step S10). For example, the user uploads the analysis model (file) to the AI model management apparatus 100 via the input device 30.

Next, the analysis model is registered in the repository 10 (Step S11). This is performed by the model information input unit 21b. Specifically, the model information input unit 21b associates the analysis model (file) and the learning candidate data that the user has input (uploaded) from the input device 30 with the case registered in advance and registers (stores) the associated information in the repository 10 (the model information storage unit 11b).

Next, it is determined whether the analysis model satisfies the evaluation criteria (Step S12). This determination is one example of determination means according to the present disclosure, and performed by the accuracy calculation unit 22a and the degradation determination unit 22b. Specifically, first, the accuracy calculation unit 22a calculates accuracy index values such as a mean absolute error from data of the analysis model registered in the repository 10 (the model information storage unit 11b). Next, the degradation determination unit 22b compares the results of the calculation in the accuracy calculation unit 22a with the values of the evaluation criteria registered from the design information input unit 21a in advance and determine whether or not the evaluation criteria are met. For example, the accuracy index values calculated by the accuracy calculation unit 22a are compared with the degradation determination thresholds (degradation determination thresholds associated with the degradation cause classifications set as the evaluation criteria (at the time of hypothesis verification) or the evaluation criteria (at the time of production run) in the analysis overview). When the display conditions in the recommendation template are met, it is determined that the analysis model does not satisfy the evaluation criteria. On the other hand, when the display conditions in the recommendation template are not met, it is determined that the analysis model satisfies the evaluation criteria.

Next, when it is determined in Step S12 that the analysis model does not satisfy the evaluation criteria (Step S12: NO), an incident is issued (Step S13). This is one example of extraction means according to the present disclosure and is performed by the degradation determination unit 22b. Specifically, the degradation determination unit 22b generates (extracts) information (incident) to be input to the AI model degradation cause estimation apparatus 50 from data of the analysis model (results of the prediction, prediction target data) and the parameters (degradation determination thresholds).

The processing in Steps S12 and S13 is repeatedly executed, and the number of times of repetition corresponds to the number of degradation cause classifications.

When it is determined in Step S12 that the analysis model satisfies the evaluation criteria (Step S12: YES), processing of Step S13 and the following processing are executed according to an instruction from the user (Step S14).

Next, the degradation cause is estimated (Step S15). This is performed by the degradation cause estimation unit 22c. The degradation cause estimation unit 22c inputs information on the incident (at least results of the prediction, prediction target data, and the degradation determination threshold) to the AI model degradation cause estimation apparatus 50 (one example of input means according to the present disclosure) and acquires information on the degradation cause from the output of the AI model degradation cause estimation apparatus 50 (Steps S16-S18). This is one example of accuracy degradation cause acquisition means according to the present disclosure. The AI model degradation cause estimation apparatus 50 estimates (specifies) the degradation cause of the analysis model by executing predetermined processing based on the information on the incident input from the information processing apparatus 100 (the processing apparatus 20) and outputs information on the degradation cause that has been estimated. The information on the degradation cause includes information on the degradation cause classification (degradation cause classification ID) and the part (record, column) which causes degradation in the analysis data.

Next, recommendation issuing processing is executed (Step S19). This is one example of improvement measure acquisition means according to the present disclosure.

FIG. 7 is a flowchart of the recommendation issuing processing.

First, degradation cause classifications that correspond to all the degradation causes are acquired, and are rearranged in an order of priorities (Step S191). This is one example of degradation cause classification acquisition means according to the present disclosure. Specific examples of the degradation cause classifications acquired here are shown in FIG. 8.

Next, a recommendation template that corresponds to the degradation cause classification is acquired (Step S192). This is one example of recommendation template acquisition means according to the present disclosure.

Next, it is checked whether or not the search target data satisfies the display conditions (Step S193). This is one example of check means according to the present disclosure. Specific examples of the search target and the display conditions are shown in FIG. 8.

Next, a recommendation (message) having the result (Y/N) of the check in Step S193 as the display condition determination result (Y/N) is issued (Step S194). This is one example of message acquisition means according to the present disclosure.

The processing in the above Steps S192-S194 is repeatedly executed, and the number of times of repetition corresponds to the number of degradation cause classifications acquired in Step S191 (Step S195: NO).

When no degradation cause has been acquired in Step S191 (Step S195: YES), the processing is interrupted.

Referring once again to FIG. 6, description of an operation example will be continued.

After the recommendation issuing processing is completed, next, the incident (the incident ID of the incident issued in Step S13) and recommendations (recommendation IDs of the recommendations issued in Step S19) are registered as the evaluation results (Step S20).

Next, a list of recommendations is displayed (Step S21). This is one example of display means according to the present disclosure. For example, information on the recommendations issued in S19 is displayed on the output device 40 in a form of a list. Specific examples of the recommendations (a form of the list) are shown in FIG. 9 (see improvement recommendations in FIG. 9).

Next, the user selects a recommendation to be adopted from the recommendations displayed in the list (Step S22).

Next, when there is at least one recommendation that has been adopted (Step S23: YES), a problem having information on the recommendation (e.g., a problem having a recommendation ID the same as that of the recommendation selected in Step S22) and a case for solving this problem are issued (Step S24). This is one example of registration means according to the present disclosure. For example, the evaluation information input unit 21c registers the improvement measure that the recommendation has in the repository 10 as a problem that is to be addressed in the next case. Further, the design information input unit 21a registers data of the above case in the repository 10. When there is no recommendation that has been adopted (Step S23: NO), the processing is ended.

Next, the user performs the improvement measure to create an analysis model, and registers the analysis model in the information processing apparatus 100 (the AI model management apparatus) again (Step S10). Then, Step S11 is repeatedly executed. As a result, a plurality of cases are issued. When, for example, a series of processing from the incident issuing (Step S13) to the recommendation issuing (Step S19) is performed for the case A and processing up to Step S24 is completed, a case B for solving the problem derived from the case A is issued.

Next, processing for tuning the parameters (degradation determination thresholds) to be passed to the AI model degradation cause estimation apparatus 50, which the parameters included in the incident issued in Step S13 (one example of parameter update means according to the present disclosure) will be described.

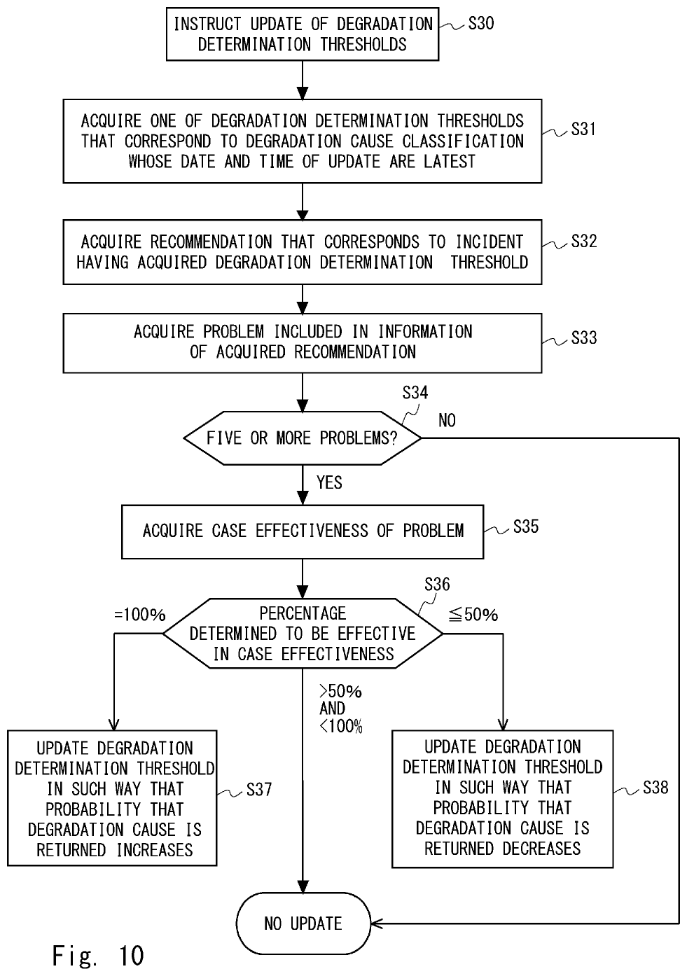

FIG. 10 is a flowchart of processing for tuning the parameters (degradation determination thresholds) to be passed to the AI model degradation cause estimation apparatus 50.

The values of the parameters (degradation determination thresholds) to be passed to the AI model degradation cause estimation apparatus 50 are set by a person in charge based on the experience of the past analysis work and intuition (intuition based on the experience), and it is difficult for a third party to tune these values.

On the other hand, by executing processing in FIG. 10, the parameters (degradation determination thresholds) to be passed to the AI model degradation cause estimation apparatus 50 are tuned based on data accumulated in the information processing apparatus 100 (the AI model management apparatus). Accordingly, it is possible to increase the probability of the AI model degradation cause estimation apparatus 50 outputting the correct cause of the accuracy degradation.

First, update of the degradation determination thresholds is instructed (Step S30). For example, the user performs an operation for updating the values of the degradation determination thresholds registered in the repository 10 via the input device 30.

Next, one of the degradation determination thresholds that correspond to the degradation cause classification whose date and time of update are the latest is acquired (Step S31). This is performed by the design information input unit.

Next, the recommendation that corresponds to the incident having the degradation determination threshold acquired in Step S31 is acquired (Step S32). The incident and the recommendation correspond to each other via a degradation cause (see FIG. 3). Therefore, by narrowing down the coupling table of the recommendation and the degradation cause by the incident ID, the recommendation that corresponds to the incident can be acquired.

Next, a problem having the information of the recommendation acquired in Step S32 is acquired (Step S33). Specifically, a problem having the ID (recommendation ID) in the recommendation acquired in Step S32 is acquired.

Next, when five or more problems have been acquired in Step S33 (Step S36: YES), processing of Step S35 and subsequent processing are executed. On the other hand, when less than five problems have been acquired in Step S33 (Step S34: NO), it is determined that update is not performed and the processing is ended. The number of problems acquired in Step S33 becomes five or larger when same recommendation has been adopted five or more times as a result of repeating the processing in FIG. 6. The reason why the number of problems acquired in Step S33 is set to five or more is to obtain a minimum number of populations in the processing of Step S36.

Next, case effectiveness (presence or absence of case effect) of the problem is acquired (Step S35). Since the result indicating whether or not the analysis model registered in the case that corresponds to the problem (=the case in which the improvement measure shown in the recommendation is executed) is registered in the repository 10 as case effectiveness (presence or absence of case effect), this information is acquired. Note that the case effectiveness (presence or absence of case effect) is registered at a timing when the model is evaluated in an AI model management apparatus that is different from the information processing apparatus 100 shown in FIG. 2 (the AI model management apparatus) (in Japanese Unexamined Patent Application Publication No. 2020-38527, a timing when the evaluation record is created).

Next, the degradation determination threshold is updated in accordance with the percentage that it is determined to be effective in view of the case effectiveness (Step S36-S8).

When, for example, the percentage that it is determined to be effective is high (Step S36: =100%), it is highly likely that this improvement measure is also effective in another analysis model as well. Therefore, the value of the parameter (degradation determination threshold) is updated in such a way that the probability that the degradation cause that corresponds to this recommendation is output from the AI model degradation cause estimation apparatus 50 increases (Step S37).

On the other hand, when the percentage that it is determined to be effective is low, it is highly likely that false detection is performed many times. In this case, the value of the parameter (degradation determination threshold) is updated in such a way that the probability that the degradation cause is output decreases (Step S38).

As described above, according to the second example embodiment, the output device 40 displays an improvement measure (recommendation, see improvement recommendations in FIG. 9) of the analysis model that corresponds to the cause of the accuracy degradation of the analysis model, whereby it is possible to present an appropriate improvement measure.

Further, according to the second example embodiment, the parameters (degradation determination thresholds) to be passed to the AI model degradation cause estimation apparatus 50 are tuned based on the data accumulated in the information processing apparatus 100 (the AI model management apparatus). Accordingly, it is possible to increase the probability of the AI model degradation cause estimation apparatus 50 outputting the correct cause of the accuracy degradation.

Further, according to the second example embodiment, by recommending an improvement measure when the performance of an analysis model is not sufficiently high or degraded, an improvement measure having a certain quality can be obtained regardless of an operator, and the efficiency of the analysis model improvement work is increased.

Further, according to the second example embodiment, by automatically updating values of parameters to be passed to the AI model degradation cause estimation apparatus 50 based on a result of an analysis model improvement work, it is possible to tune parameters in such a way that the probability of the AI model degradation cause estimation apparatus 50 outputting the correct cause of the accuracy degradation is increased regardless of an operator.

While the example in which Step S12 is used has been described in the second example embodiment, automatic determination processing of the evaluation criteria shown in Step S12 may be omitted. According to the aforementioned configuration, the aforementioned effect can be obtained as well.

### Other Example Embodiments

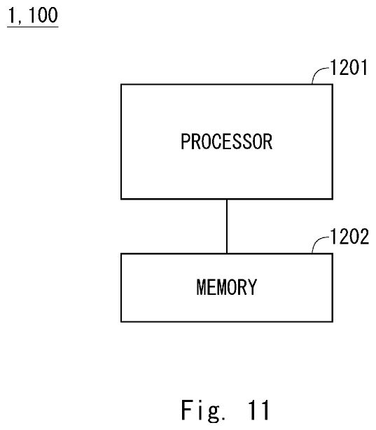

The information processing apparatus 100 described in the aforementioned example embodiments may include the following hardware configuration. FIG. 11 is a diagram showing a hardware configuration example of the information processing apparatus according to the present disclosure.

Referring to FIG. 11, the information processing apparatus 100 includes a processor 1201 and a memory 1202. The processor 1201 loads software (computer program) from the memory 1202 to execute the loaded software (computer program), thereby performing processing of the information processing apparatus 100 described with reference to the flowchart in the aforementioned example embodiments. The processor 1201 may be, for example, a microprocessor, a Micro Processing Unit (MPU), or a Central Processing Unit (CPU). The processor 1201 may include a plurality of processors.

The memory 1202 is composed of a combination of a volatile memory and a non-volatile memory. The memory 1202 may include a storage located apart from the processor 1201. In this case, the processor 1201 may access the memory 1202 via an Input/Output (I/O) interface that is not shown.

In the example shown in FIG. 11, the memory 1202 is used to store software modules. The processor 1201 loads these software modules from the memory 1202 and executes the loaded software modules, thereby performing processing of the information processing apparatus 100 described in the aforementioned example embodiments.

As described above with reference to FIG. 11, each of one or more processors included in the information processing apparatus 100 executes one or more programs including instructions for causing a computer to execute the algorithm described with reference to the drawings.

In the aforementioned examples, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the aforementioned example embodiments and may be changed as appropriate without departing from the scope of the present disclosure. Further, the present disclosure may be executed by combining example embodiments as appropriate.

### REFERENCE SIGNS LIST

1 Information Processing Apparatus
2 Accuracy Degradation Cause Acquisition Means
3 Improvement Measure Acquisition Means
4 Display Means
10 Repository
11 Information Holding Unit
11a Design Information Storage Unit
11b Model Information Storage Unit
11c Evaluation Information Storage Unit
20 Processing Apparatus
21 Information Input Unit
21a Design Information Input Unit
21b Model Information Input Unit
21c Evaluation Information Input Unit
22 Information Analysis Unit
22a Accuracy Calculation Unit
22b Degradation Determination Unit
22c Degradation Cause Estimation Unit
22d Recommendation Unit
30 Input Device
40 Output Device
50 AI Model Degradation Cause Estimation Apparatus
100 Information Processing Apparatus (AI Model Management Apparatus)
1201 Processor
1202 Memory

What is claimed is:

1. An information processing apparatus comprising:
at least one memory storing instructions, and
at least one processor configured to execute the instructions to;
acquire a cause of accuracy degradation of a machine learning model;
acquire an improvement measure of the machine learning model that corresponds to the cause of the accuracy degradation of the machine learning model;
display the improvement measure of the machine learning model
acquire a degradation cause classification that corresponds to the cause of accuracy degradation of the machine learning model;
acquire a recommendation template that corresponds to the degradation cause classification;
check whether or not search target data in the recommendation template satisfies display conditions in the recommendation template; and
acquire a message that corresponds to the result of the check in the recommendation template as the improvement measure of the machine learning model.

2. The information processing apparatus according to claim 1, further comprising:
determination means for determining whether or not the machine learning model satisfies evaluation criteria;
extraction means for extracting information that is required to estimate the cause of the accuracy degradation from data of the machine learning model that has been determined not to satisfy the evaluation criteria; and
input means for inputting information that is required to estimate the cause of the accuracy degradation to a degradation cause estimation apparatus,
wherein the accuracy degradation cause acquisition means acquires an improvement measure of the machine learning model that corresponds to the cause of the accuracy degradation of the machine learning model output from the degradation cause estimation apparatus.

3. (canceled)

4. The information processing apparatus according to claim 1, comprising:
registration means for registering a result of an operation performed by a user on the improvement measure of the machine learning model; and
parameter update means for updating a parameter, which is information that is required to estimate the cause of the accuracy degradation of the machine learning model based on the result of the operation performed by the user.

5. The information processing apparatus according to claim 4, wherein
the registration means issues a problem when the user has selected the improvement measure of the machine learning model displayed on the display means, and
the parameter update means updates the parameter in accordance with a percentage that it is determined to be effective in view of case effectiveness in the issued problem when the number of issued problems is equal to or larger than a predetermined number.

6. The information processing apparatus according to claim 1, wherein the information that is required to estimate the cause of the accuracy degradation includes a result of the prediction, prediction target data, and a degradation determination threshold.

7. An information processing method comprising:
acquiring a cause of accuracy degradation of a machine learning model;
acquiring an improvement measure of the machine learning model that corresponds to the cause of the accuracy degradation of the machine learning model; and
displaying the improvement measure of the machine learning model;
acquiring a degradation cause classification that corresponds to the cause of accuracy degradation of the machine learning model;
acquiring a recommendation template that corresponds to the degradation cause classification;
checking whether or not search target data in the recommendation template satisfies display conditions in the recommendation template; and
acquiring a message that corresponds to the result of the check in the recommendation template as the improvement measure of the machine learning model.

8. A non-transitory computer readable medium storing a program for executing an information processing method, wherein the information processing method comprises:
acquiring a cause of accuracy degradation of a machine learning model;
acquiring an improvement measure of the machine learning model that corresponds to the cause of the accuracy degradation of the machine learning model; and
displaying the improvement measure of the analysis machine learning model;
acquiring a degradation cause classification that corresponds to the cause of accuracy degradation of the machine learning model;
acquiring a recommendation template that corresponds to the degradation cause classification;
checking whether or not search target data in the recommendation template satisfies display conditions in the recommendation template; and
acquiring a message that corresponds to the result of the check in the recommendation template as the improvement measure of the machine learning model.
